(19) United States
(12) Patent Application Publication
(10) Pub. No.: US 2011/0160948 A1
(43) Pub. Date: Jun. 30, 2011

(54) AUTOMATIC REMOTE CONTROLLED HOSPITAL DISPENSING CART

(75) Inventors: Kenneth Stephen Bailey, San Jose, CA (US); Paul Salvador Mula, San Jose, CA (US)

(73) Assignee: Clear View Technologies, Inc

(21) Appl. No.: 12/958,133

(22) Filed: Dec. 1, 2010

Related U.S. Application Data
(60) Provisional application No. 61/283,454, filed on Dec. 2, 2009.

(51) Int. Cl. G06F 7/00; G05D 1/00

(52) U.S. Cl. 701/23; 700/236

(57) ABSTRACT

A portable dispensing device that can be used in a hospital to dispense drugs or can be used to dispense alcoholic beverages. A cart may store and dispense dispensible items, e.g., drugs, to patients room by room as are periodically prescribed by their physicians. The drugs are automatically billed and automatically verified as being properly dispensed.

This application claims priority from provisional application No. 61/283,454, filed Dec. 2, 2009, the entire contents of which are herewith incorporated by reference.

### BACKGROUND

Many prescription errors are made during the various phases of medication usage in the hospital environment. Dispensing of drugs in a hospital is a very sensitive phase of the medication used in the hospital. Safe, organized, and effective dispensing systems are, therefore, fundamental to ensure that drugs will be properly dispensed according to the prescription order forms, and to reduce the possibility of errors.

The use of medication may present shortcomings due to the many mistakes which individually would not be enough to cause errors. These are latent mistakes, dynamic as the system is, and capable of variation as a function of different possible situations. The creation of oversight for the system focuses on preventing these mistakes, either isolated or in synergistic action, that result in errors.

In a study carried out in 1994 in the USA, it was demonstrated that transcription and administration could be responsible for 50% of the medication errors, considering that 39% of the errors involved prescription order forms and 11% involved dispensation. A British study from 2002 reported a 2.1% rate of dispensation errors.

The most frequent type of error was medication dispensed with an incorrect dose. The dispensation error rate found in an American study in 2003 was 3.6%. The differences between the rates reported in these studies can be related to the different methodologies that have been applied. They can also be related to the improvement in the dispensation systems and actions to reduce dispensing errors implemented in these countries.

Today, there are different drug dispensing systems in hospital units, and a different expectation of errors is associated with each of them. It is known that in American, British, and Canadian hospitals where the unitary dose (UD) system is used, the rate of medication errors has been reduced from 1 error/patient/day to 2-3 errors/patient/week.

It has also been observed that the rates of drug dispensing errors in work environments with high levels of interruption, distraction, noise, and overload are higher (3.23%) compared with the environments with lower levels of these aspects (1.23%).

In Brazil, research regarding medication errors in hospitals is scarce. The 1990s and the first years of the current century saw the beginning of coordination among pharmaceutical groups. This occurred in an attempt to determine the realities of the work conditions and their effects on the quality of the provided services, as well as to overcome bureaucracy and master the techniques of efficient hospital pharmacy operation in the country. In a broad bibliographical research about the dispensing errors in Brazil, very few reports mentioned the errors that occurred, or that were related to failures in the drug dispensing system. In one of them, the errors totaled 26.8% of the procedures.

Errors in the drug dispensing system included the following: delay in the dispensing time; medication with similar labeling and packaging; many drugs to be given at the same time, with the consequent delay in the administration; and drugs sent with the wrong identification.

Studies have been made to detect and to analyze drug dispensing errors. These studies may be used to identify associated factors, and to suggest preventative actions.

A cross-sectional study was performed to evaluate the drug-dispensing process used by the mixed system in a public hospital in Belo Horizonte, Minas Gerais, having 276 beds and specializing in emergencies and urgent care. The measure of dispensation error adopted was the discrepancy between the written instruction found on the prescription order form and the accomplishment of this instruction by the pharmacy when the drug was dispensed to the wards or hospital services. Data collection was performed during the day in the place where the medication was dispensed to pediatrics, intermediary care, neurology, internal medicine, surgery, plastic surgery, acute and chronic burn units, and the intensive care units. Three teams of professionals (who worked every 3rd day) were responsible for the drug-dispensing process. From Monday to Friday in the afternoon, a pharmacist was responsible for the dispensing process and for the supervision.

The following were excluded from the study: oral use liquids, injectables given at higher volumes, frequently used ointments, and prescriptions where a direct comparison between dispensation and the medical prescription was impossible due to the use of a multidose system. Also excluded were thermolabile drugs, eye drops, suppositories, and narcotics, given that checking would delay delivery as these drugs are separated when a nurse goes to the pharmacy to fetch the medication.

Drugs dispensed as individualized doses were included in the study as follows: oral-use solids, injectable drugs of low volume, and creams and ointments of low consumption.

The prescription under conditional form (“at doctor's orders” or “if necessary”) has rules that aim to decrease the quantity of drugs dispensed and reduce the amount of drugs stored at the hospital. These medications and the psychotropic drugs (controlled by law) have a dispensed quantity limited to 1 daily dose. If necessary, nurses could request additional units from the pharmacy. These rules were considered for identification of errors.

Data collection was carried out after 10 days of taking part in the routine and applying participant observation with the adoption of a “field diary” and after 3 days of a pilot collection. During this time, the form was tested, and parameters for calculation and arrangement of the sampling were defined. One of the aims was to introduce a professional in the routine of work, and thus to decrease the risk of collection bias. An average of 220 prescription order forms were dispensed per day and 50% was defined for the expected occurrence of the event of errors with a confidence level of 95%, reaching a final n of 462. Systematic collection took place during 21 consecutive days, in September 2002, involving 7 days of work from each team. Medications separated for dispensing were registered in the form. Afterwards, these data were compared with the prescription order forms. The qualitative observations allowed an evaluation of the dispensing service.

The variables considered and their definitions were: (1) date of the prescription and dispensation, the prescription origin sector, the name of the patient, the ward number, the bed and the staff responsible for drug dispensing; (2) type of team in the shift “complete,” as the one comprising 4 professionals; “incomplete,” as the team with 3 professionals; and “replaced,” as that team that worked with 3 of one team and 1 of another team as a substitute due to vacation reasons; (3) separated medications to be dispensed (name of the medicine, pharmaceutical formula, concentration, and dispensed amount); (4) prescribed medication (name, pharmaceutical form, concentration, and time of administration); (5) quantity of prescribed medication, with its commercial or generic name, (6) whether the medicine is standardized or not in the hospital or if there is a shortage of it in the pharmacy; (7) legibility of the carbon copy of the prescription order form “legible handwriting”, ie, read without assistance, with a normal time required for comprehension of words, numbers, symbols, and abbreviations; “poorly legible or doubtful handwriting”, i.e., in which a longer time was needed to read the prescription order form, not being completely sure of the understanding of every word, number, symbol, or abbreviations, in many occasions with a partial comprehension of what was written, (8) type of prescription “written”, ie, handwritten; “typewritten”, ie, standardized by the sector and pressed by the printer or elaborated in the computer; and “mixed”, ie, part hand-written and part type-written; (9) drugs with quality deviations or labelling problems.

The errors identified were classified into 7 types (Table 1). Data were analyzed for their simple frequency and through the uni- and bivariate analysis (using EPI INFO 6;04) and through the multivariate analysis (using STATA). The project was approved by the Committees of Ethics on Research at the organization in which it was carried out and at the Federal University of Minas Gerais (UFMG).

TABLE 1
Classification of the types of dispensing errors used for data collection
Types of dispensing error

Dose omissions no dose (unit) of the prescribed drug was dispensed or the
number of the dispensed doses was lower
Medication prescribed without administration schedule or without the
quantity to be administered or without concentration or without
pharmaceutical form, and that was dispensed
Dispensed medication with wrong concentration. ie. a concentration lower
or higher in than the prescribed
Excessive dose 1 or more doses (units) were dispensed beyond the
quantity described in the prescription.
Wrong dispensed medication a medication was prescribed, but another was
dispensed, or a nonprescribed medication was dispensed.
Medication dispensed with a wrong pharmaceutical form
Medication dispensed with labelling problems or with quality deviation

A total of 422 prescription order forms were analyzed (average, 20.1±2.1 SD prescriptions/day) totalling 2,143 dispensed drugs. The sample was proportionally distributed among the 8 admission sectors. At least 1 dispensing error was registered in 81.8% (345) of the prescription order forms. Among those, 72.7% (251) showed 1 or 2 drugs dispensed with some type of error. Out of the 719 (33.6%) drugs dispensed with some type of error, 365 (50.8%) were prescribed using the generic name, and 354 (49.2%) using the commercial name.

The most frequent error was dose omission (Table 2), and 58.5% (241) of these occurred with the drugs prescribed under conditional form, of which 46.8% (193) had omission of all doses. Heparin represented 89.7% (52) of the 8% of drugs prescribed without concentration. Heparin was also involved in all errors with drugs prescribed without the amount (2.8%) and effectively dispensed. From the 9.3% of the drugs dispensed in excessive doses ˜77.6% (52) were prescribed under conditional form.

TABLE 2
Distribution of the frequencies of the types of dispensing errors

| Types of dispensation errors | Frequencies | % | Total |
|---|---|---|---|
| Dose omission | 412 | 100 | 57.3 |
| All the doses | 320 | 77.7 | 44.5 |
| 1 or more doses | 92 | 22.3 | 12.8 |
| Medication prescribed without concentration. | 96 | 100 | 13.3 |
| quantity, time or pharmaceutical form | | | |
| Without concentration | 58 | 60.4 | 8.0 |
| Without quantity | 20 | 20.8 | 2.8 |
| Without timing | 17 | 17.7 | 2.4 |
| Without pharmaceutical form | 1 | 1.1 | 0.1 |
| Medication dispensed with wrong | 91 | 100 | 12.7 |
| concentration | | | |
| With higher concentration | 87 | 95.6 | 12.1 |
| With lower concentration | 4 | 4.4 | 0.6 |
| Excessive dose | 67 | 100 | 9.3 |
| Wrong medication | 25 | 100 | 3.5 |
| Not prescribed but dispensed | 22 | 88 | 3.1 |
| One medication prescribed and another | 3 | 12 | 0.4 |
| dispensed | | | |
| Medication with labelling problems | 23 | 100 | 3.2 |
| Correct medication, wrong pharmaceutical | 4 | 100 | 0.6 |
| form | | | |
| Medication with quality deviation | 1 | 100 | 0.1 |
| TOTAL | 719 | — | 100 |

The “C” team, the pretyped prescription order forms, the number of drugs per prescription, and the injectable pharmaceutical form were shown to be significant determinants of drug dispensing errors. There was no significant association between the percentage of errors and the legibility of prescription order forms (Tables 3 and 4), and none of the prescription order forms for medication was classified as illegible. Pretyped and mixed prescription order forms showed higher rates of dispensing errors and a higher number of drugs prescribed (Table 3 and 4). Apart from legibility issues, these prescriptions were kept in the multivariate model as a risk factor for dispensing errors. In this model, the number of drugs/prescription and the team responsible for dispensing were also at a higher risk of error (Table 5).

TABLE 3
Prescriptions with dispensation errors according to the team, type
of prescription order form, the handwriting, and the amount
of drugs per prescription

| Variable analyzed | n | % error | OR (CI) | P | |
|---|---|---|---|---|---|
| Team | A | 136 | 75.7 | 1.00 | — |
| | B | 144 | 81.3 | 1.39 (0.75-2.56) | .328 |
| | C | 142 | 88.0 | 2.36 (1.19-4.70) | .012 |
| | C × (A + B) | — | — | 2.01 (1.08-3.75) | .025 |
| Type of prescription order form | Written | 97 | 66.0 | 1.00 | — |
| | Mixed | 189 | 84.1 | 2.73 (1.48-5.05) | .000 |
| | Typewritten in advance | 136 | 89.7 | 4.49 (2.14-9.56) | .000 |
| Handwriting | Legible | 296 | 83.8 | 1.00 | — |
| | Almost legible | 126 | 77.0 | 0.65 (0.37-1.12) | .129 |
| Number of drugs/prescription | 0-9 | 253 | 74.7 | 1.00 | — |
| | 10-26 | 169 | 92.3 | 4.06 (2.08-8.06) | .000 |

Number of prescriptions n = 422:
OR = odds ratio:
CI = 95% confidence interval

TABLE 4
Medications dispensed with errors according to the team, kind
of prescription order form, handwriting, and pharmaceutical form

| Variable analyzed | n | % error | OR (CI) | P | |
|---|---|---|---|---|---|
| Team | A | 730 | 29.9 | 1.00 | — |
| | B | 706 | 32.6 | 1.13 (0.90-1.43) | .292 |
| | C | 707 | 38.3 | 1.46 (1.17-1.83) | .000 |
| | C × (A + B) | — | — | 1.37 (1.13-1.66) | .001 |
| Type of prescription order form | Writen | 321 | 29.1 | 1.00 | — |
| | Mixed | 1151 | 35.8 | 0.74 (0.56-0.96) | .025 |
| | Pre-typed | 671 | 40.1 | 1.20 (0.90-1.59) | .222 |
| Handwriting | Legible | 1483 | 35.0 | 1.00 | — |
| | Almost legible | 660 | 30.5 | 0.82 (0.67-1.00) | .048 |
| Pharmaceutical form | Oral | 1333 | 20.3 | 1.00 | — |
| | Topical | 62 | 29.0 | 3.32 (1.83-6.10) | .000 |
| | Injectable | 748 | 57.6 | 5.35 (4.37-6.55) | .000 |
| | Injectable × (Oral + Topical) | — | — | 5.23 (4.28-6.38) | .000 |

Dispensed medications n = 2143:
OR = odds ratio:
CI = 95% confidence interval

TABLE 5
Multivariate analysis of the dispensing error indicators

| Error Indicator | OR (CI) | P |
|---|---|---|
| Sunday | 1.83 (0.67-4.99) | .235 |
| Tuesday | 3.15 (0.97-10.18) | .055 |
| Wednesday | 1.86 (0.64-5.37) | .253 |
| Thursday | 1.26 (0.47-3.38) | .647 |
| Friday | 1.38 (0.47-1.05) | .559 |
| Saturday | 1.38 (0.49-3.89) | .545 |
| Team A | 0.05 (0.008-0.32) | .001 |
| Team B | 0.17 (0.04-0.79) | .024 |
| Complete team | 7.53 (1.08-52.27) | .041 |
| Incomplete team | 1.58 (0.33-7.54) | .563 |
| Pretyped prescription order form | 3.28 (1.43-7.55) | .005 |
| Mixed prescription | 1.36 (0.68-2.70) | .380 |
| Legible handwriting | 1.07 (0.57-2.00) | .829 |
| Number of medications prescribed | 1.23 (1.13-1.35) | .000 |

OR = odds ratio:
CI = 95% confidence interval

From 431 injectable drugs dispensed with errors, 134 (31%) were high-risk medications heparin comprised 67.2% (90), and nalbupbine comprised 22.4% (30). Examples of dispensing errors according to the different types encountered are shown in Table 6.

TABLE 6
Examples of the types of dispensing errors

| Prescribed medication | Dispenced medication |
|---|---|
| Dose emission | |
| metaelopromide 1 vial 8/8 h IV | None |
| metaelopromide 1 vial 8/8 h IV | 1 vial metaelopromide |
| Medication prescribed without concentration, | |
| quantity, time or pharmaceutical form | |
| heparin 0.25 mL 12/12 h SC | heparin 0.25 mL/5000 IU or 5 mL/5000 IU |
| heparin 0.25 mL/5000 IU 12/12 h SC | heparin 0.25 ml/5000 UI |
| codeine 30 mg + Acetaminophen 500 mg if pain | codeine 30 mg + acetaminophen 500 mg |
| dipyrone 6/6 h VO | dipyrone 500 mg tablets |
| Medication dispensed withwrong concentration | |
| iron sulphate 200 mg | iron sulphate 300 mg |
| diazepan 10 mg | diazepan 5 mg |
| Excessive done | |
| nalbuphine 0.5 mL 6/6 h SC if intense pain | 4 vials of nalbuphine |
| Wrong Medication | |
| None | 3 vials depanine |
| Taxocin^{§} | Levaquin^{§} |

Prescription order forms involving injectable drugs are generally more complex, and can create more uncertainties and more dispensing errors. Errors involving injectable drugs have a higher potential for causing severe damage to the patients and adverse events than medication administered through other routes, in addition to the operational aspects related to their preparation and administration. Furthermore, after being injected, the drug cannot be recovered, and its effects are difficult to reverse. The frequency in which the high-risk medication is dispensed with error shows the need for establishing different procedures for storage and dispensing areas as a preventative strategy.

Despite recommendations of applying extreme care in its use, heparin is one of the drugs that is closely related to life-threatening situations of patients in hospital environments.

Heparin was shown to be one of the 10 medications responsible for 60% of the adverse events that occurred in hospitals during a study between the years 1994 and 2000. In the same hospital in which this study was carried out, Rosa (2002) reported a frequency of 58% of the prescriptions of heparin without the pharmaceutical form, 40% with incomplete concentration, 20% without concentration, and 14% without administration route.

Applicant recognized a need for adjustment of these measures to different socio-cultural work realities and the characteristics of the different types of errors and problems in these environments. Therefore, the prevention of errors demands initiatives that include all the components of the system, and its application is the responsibility of organizations, health authorities, and all professionals involved pharmacists, nurses, and doctors.

Another issue is accountability. As an example, Coney Island Hospital couldn't account for $3.75 million worth of drugs during an audit in 2007, according to city Comptroller Bill Thompson, who questioned if the medications were lost in sloppy record-keeping, stolen or “flushed down the toilet . . . , the drugs were either stolen, doled out to various hospital units without being recorded, or flushed down the toilet.”

The Health and Hospitals Corp., which operates Coney Island Hospital, responded that most of the drugs were legitimately dispensed to patients but that it took time for the paperwork to reflect that.

But the city comptroller's auditors didn't accept that explanation. “We were not provided sufficient information in order to determine the accuracy of that analysis,” they wrote. “The large number and size of discrepancies lead us to conclude that limited reliance can be placed on the hospital's inventory records.”

During the audit, hospital officials notified the comptroller that they had improved record-keeping, replaced and trained stockroom staffers and conducted spot checks.

### SUMMARY

The present application describes a remote item dispensing system that keeps track of what is being dispensed.

Embodiments describe a moveable item dispensing system, with wireless communication capability, that keeps track of the inventory.

### BRIEF DESCRIPTION OF THE DRAWINGS

in the drawings:

FIG. 1 depicts the end to end system that is described in an embodiment;

FIG. 2 depicts a software flowchart that shows how the cart, the patient armband, the nurses ID badge, the hospital computer server and the doctor's desktop or laptop computer are interconnected for functionality according to an embodiment;

FIG. 3 depicts a flowchart that restricts the nurse from dispensing the wrong medications to the wrong patient at the wrong time of day;

FIG. 4 depicts reports that are resultantly generated by the hospital's computer server, to notify the doctor or hospital pharmacy or authorized personnel when an error or abnormal event occurs while the medications are being dispensed;

FIG. 5 depicts the internal operation of the “MEDS CART” during normal dispensing of prescribed medications.

### DETAILED DESCRIPTION

The embodiments address this long felt need as described above. The herein described system when utilized properly can eliminate these types of problems altogether.

ClearView technologies Inc., the assignee of the present application, has a number of pending applications covering the monitored dispensing of dispensable items, including application Ser. No. 11/862,347 filed Sep. 27, 2007; 12/361,443 filed Jan. 28, 2009; 12/365,143 filed Feb. 3, 2009; and others. Each of these applications are incorporated herein by reference in their entirety. These co-pending applications describe systems in which dispensable items such as drugs or alcohol are monitored using a monitoring system.

The present application uses these and other techniques to monitor the dispensing of items from a portable system such as a portable cart. The embodiments as described herein include applications of monitoring inventory in this way. One embodiment describes use of this system for dispensing prescription drugs. However, it should be understood that the system can also be used for other dispensing techniques, including, but not limited to, alcohol dispensing and others.

There are many other studies that show similar issues wherein drugs that are prescribed in a hospital can be incorrectly dispensed.

The top 50 drugs prescribed in a hospital are as follows: Aranesp, Procrit, Lovenox, Neulasta, Remicade, Zofran, Ritual, Levaquin, Zocor, Revlimid, Zosyn, Avastin, Neupogen, Propofol, Eloxatin, Protonix IV, Diprivan, Inegrilin, Herceptin, Advair diskus, Omnipaque, Protonix, Zyvox, Cefriaxone, Taxotere, Ultane, Cancidas, Thrombinjmi, Sodium chloride, Seroquel, Premixing, Angiomax, Gemunex, Carimune NF, Nanofiltered, Gemzar, Zometa, Erbitux, Prevaciad, Morphine Sulfate, Risperdal, Epogen, Zyprexa, Plavix, Camptosar, Nexium, Aciphez, Lipitor, Lupron Depot, Maxipime and Reopro. Of course, other drugs can be controlled and monitored using the techniques of the present application. However, in one embodiment, the top 50 dispensed drugs can be maintained on the portable device of the present system, and automatic dispensing can be carried out according to prescriptions.

In US hospitals there are approximately 400 beds per hospital on five floors. This averages then about 80 patient beds per floor.

Accordingly, one embodiment of a “MED CART’ may have 80 “pigeon holes”, one for each patient on each floor. In one embodiment, the medication is also stored on the cart. An embodiment may incorporate 100 separate drawers, which each hold medication. The medication is dispensed to the pigeon holes 120, 121, where each pigeon hole holding, and eventually dispensing, the medication for one patient. There may be different numbers of pigeon holes, of course.

The cart will return unused meds to the main storage area when the cart senses: 1. The patient is no longer in the room (released from the hospital), or 2. The medication has been cancelled or changed from the dosage on the cart, or 3. The patient is in therapy or x-ray and is unable to take their prescribed meds at that time.

An embodiment uses a wireless link from the cart to the central computer server database in the hospital. In a preferred embodiment, the cart may robotically move. For example, the card may move along an invisible guidance track hidden beneath the tile or carpeted flooring. The cart may be self propelled or propelled using motive elements in the track. The cart is programmed to stop in front of each successive room for which there are dispensable drugs. The cart may stop at that location until the medical personnel in charge of actually removing and dispensing the drugs for each patient's room does so, using the techniques described herein.

According to an embodiment, the cart also includes a computing part, and a communication part that updates the central computer server database as to who has received their medication, reasons for not dispensing and/or why that particular room was skipped or passed over. Each authorized person dispensing the medications needs to have an identification device of some sort. In one embodiment, the user wears a custom made arm bracelet that can be read by the reader. If the authorized dispensing person is not wearing their assigned arm bracelet, then their access to the cart is denied. When an authorized person is wearing their pre-assigned arm bracelet, then the electronics resident within the cart first reads the wearer's arm bracelet, determines if that person is authorized to dispense meds from the cart, notify the central server computer database, and then dispenses the medications only if all other conditions have been met (i.e., the patient is present, medication is as prescribed by the patient's physician and other conditions as described herein)

The cart is equipped with a battery, a, battery charger, an electric motor drive, an onboard computer, an onboard transceiver (Zig-Bee or Wi-Fi for example), 50 medication storage tanks, 100-numbered dispensing bins or drawers that remain locked until proper authorization has been obtained from the central hospital computer server's database, a user interface screen, e.g., a touch screen for user log-in to allow for discrepancies, (such as changed medications) and a real time clock.

When not being used, the cart described herein can be plugged into an AC wall outlet of 110-120 VAC in order to recharge the on board battery. The battery charger may also be a solar panel, positioned on the top of the cart or on the sides of the cart.

Further detail as described in the attached. Moreover, as previously described, the system can be used for dispensing other items, including inventory in a self-service configuration, and also for dispensing, for example, alcohol for example in a bar.

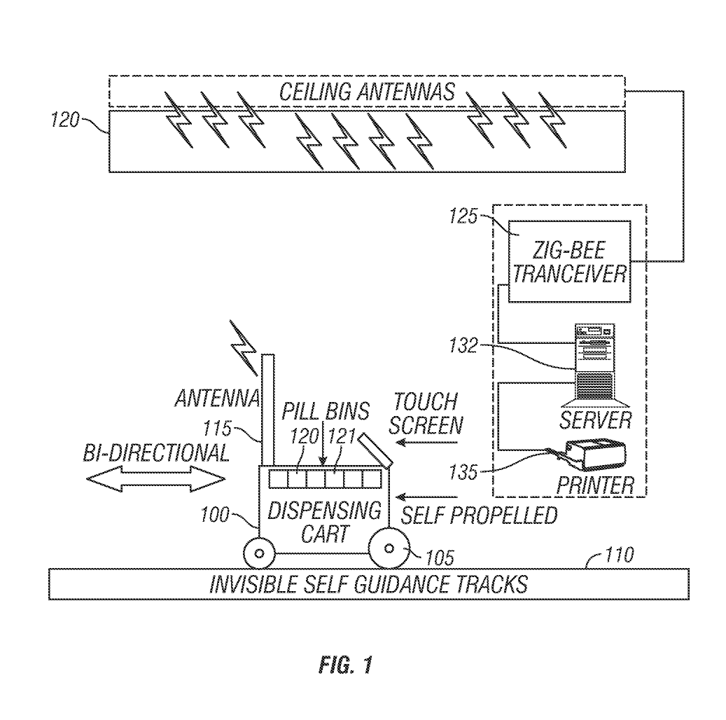

FIG. 1 illustrates the cart 100 which is on wheels 105, which enable it to be self-propelled along the track 110. In another embodiment, the cart can keep track of its position and may or may not be along a track. The cart includes an antenna 115, which communicates with on-site antennas 120 which are spaced throughout the allowable area of use of the cart, and which connect to a computer server. In one embodiment, operations of the cart may be stopped whenever the cart loses communication with the antennas. The cart in this embodiment may be self-propelled or maybe propelled using motive force.

Information from the communication describes the pills that have been dispensed and when they were dispensed. This is provided to a wireless transceiver 125. In one embodiment, this can use of mass wireless system such as Zig-Bee. In another embodiment, this can use any other kind of Wi-Fi system. The output of the wireless system 125 is communicated to a computer server which operates as according to the techniques described herein, and to a printer which prints out hospital records as necessary.

In one embodiment, the cart will not allow the drugs (or other items) to be dispensed until the billing information has been sent to the central server, and confirmation of the billing is received from the central server.

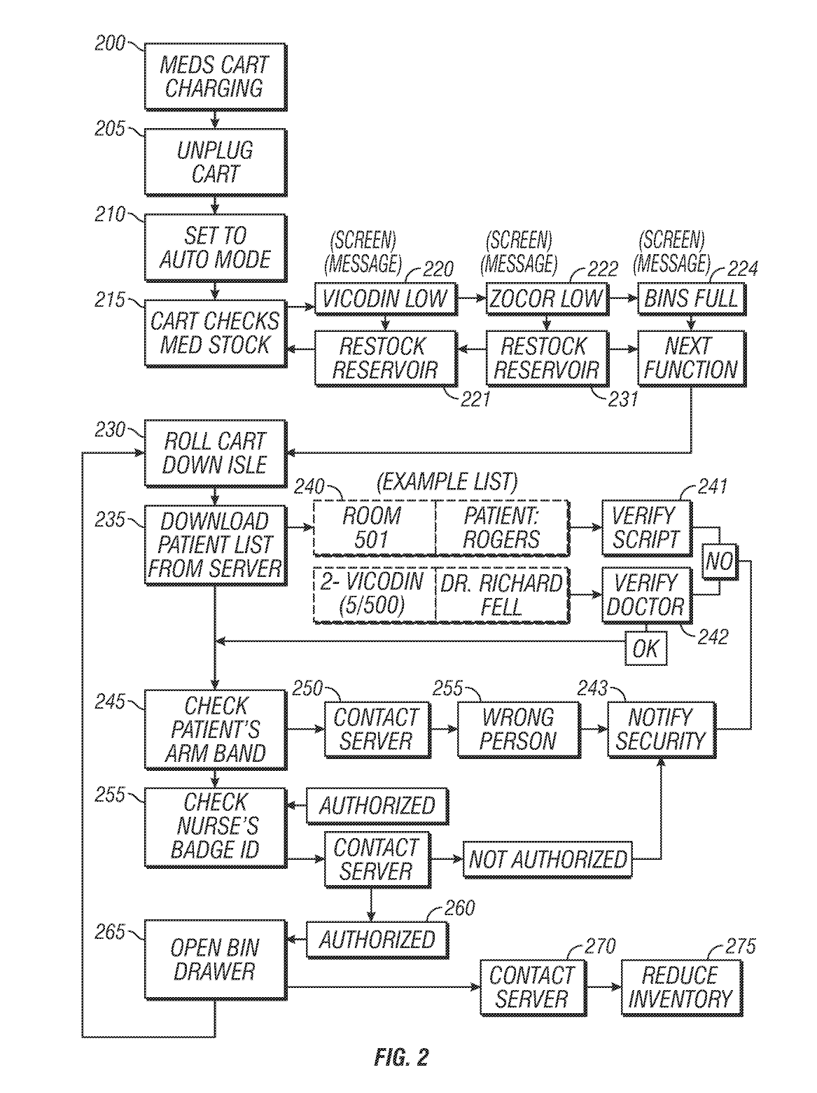

The cart operates according to the flowchart of FIG. 2. 200 illustrates the time when the cart is not being used, and during this time the cart may be charging. When the cart is unplugged from the charger at 205, it is set to automatic mode, and automatically starts its operation by checking its stock of certain items.

In this embodiment, the system checks its drugs at 220, first checking whether its supply of Vicodin is low, and if so, requesting a restocking of the reservoir at 221. Then, it checks Zocor at 222, restocking at 223. While only two are shown, there can be many other drugs checked, and restocking requests sent.

In an embodiment, the level of fill of the bins is checked by weighing the bins. In another embodiment, the level of fill is checked by weighing the items that are in the bins, and correlating the weight against a known weight per pill.

Once the bins are indicated as being full at 224 (or requests for restock have been made), control is passed to the operational part at 230 where the cart can be moved. In this embodiment, the cart is automatically moved to different locations. The first aspect of moving is downloading the patient list from the server at 235. For example, the patient list may be of the form shown in 240 which shows an example that shows in room 501, the patient's name is Rogers, Rogers gets two Vicodin 5/500s, and Rogers' doctor. is Dr. Richard Felt. In order to prevent improper prescribing, 241 may verify the script and 242 may verify the doctor. If either is incorrect, then security is notified that 243 of a possible breach. However, if both are okay, then the patient's identity is checked at 245. In this embodiment, this may use an armband that includes an RFID tag that transmits so that the cart can detect the patient's identity.

Other ways of detecting the patient's identity can also be used. For example, the identity can be detected by scanning a barcode or by a manual detection by the dispensing person.

At 250, the system contacts the server to determine if the current person is the right or wrong person. If the wrong person at 255, security is notified. If the correct person, however, flow passes to 255 which checks the dispensing badge ID. If this is authorized at 260, the bin drawers are opened at 265 to dispense the drug. The drug can be dispensed for example to a specified surface from which it can be removed, here a dispensing surface.

In the embodiment of dispensing alcoholic beverages, for example, the beverage can be dispensed into a glass or shot glass that can be put on the dispensing surface, or alternatively, for example, a beer bottle or wine bottle can be so dispensed to be removed.

After dispensing, the system automatically then contacts the server at 270 and reduces the inventory at 275.

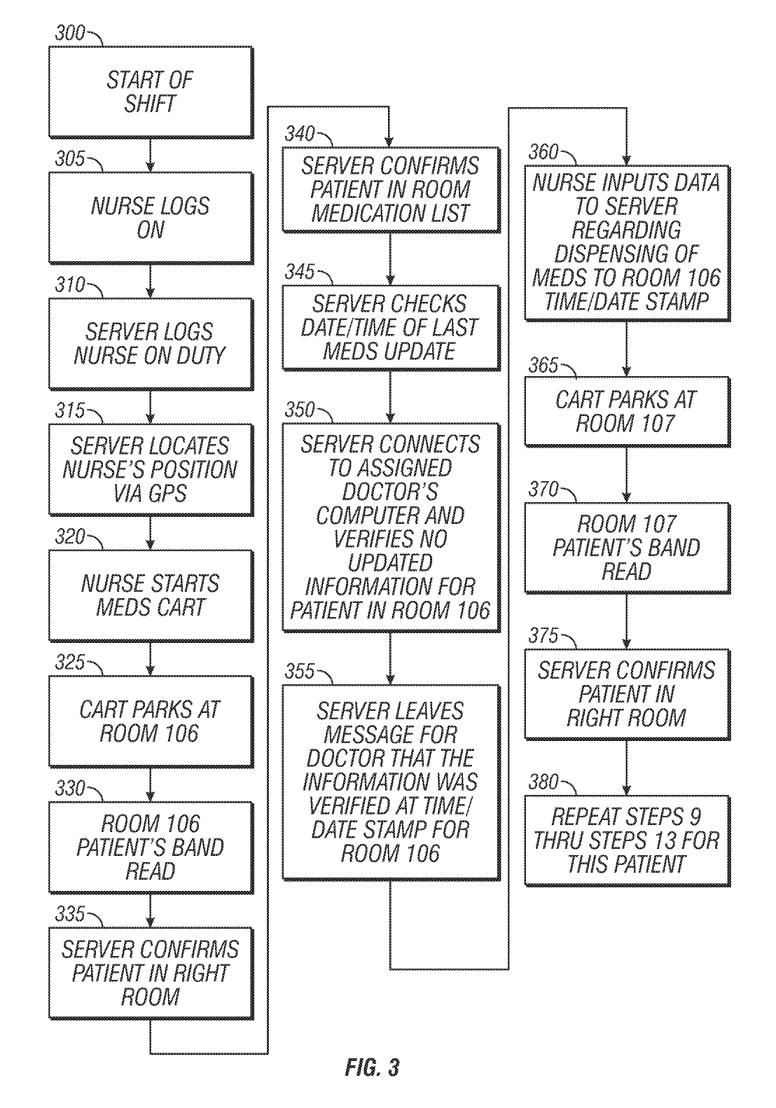

FIG. 3 shows a flowchart of operation. At the start of a shift, the nurse logs on at 305, and the server logs the nurse on duty at 310. The server locates the nurse via GPS or from the position at which the nurse logged on. The nurse then starts the meds cart at 320. The cart parks at a specified room, here room 106 at 325. The system authorizes the patient at 330 and confirms that the patient is in the correct room at 335. At 340 the server confirms that the patient is in the room, and loads the medication list. The server checks the date and time of last meds updated 345, and may at 350 verify with the doctor's computer that there are no updates. The server then leaves the doctor a message at 355. At 360, the nurse inputs the data to the server indicating that the meds have been dispensed with the date and time stamp. At this point, the drawer has been opened, and the meds have been automatically dispensed. The carton moves at 365 and parks at room 107.

In a similar way, 370 detects the patient's band, that the patient is in the right room at 375, and at 380 continues to update that the patient is in the proper place.

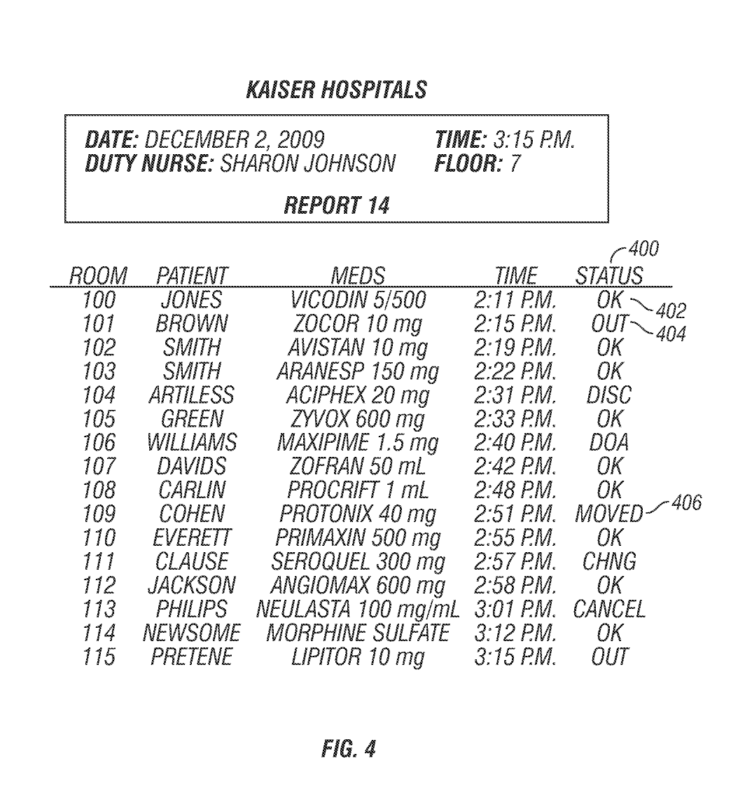

FIG. 4 shows an exemplary report which can be produced by the system automatically. This shows the room number, the patient number, the meds, the time and what was actually done. The status section 400 may show that some drugs were dispensed at 402 but other drugs may not have been dispensed at 404, because the patient was out of the room. Yet another at 406 may show that the wrong patient was in the room, and therefore that the drug was not dispensed to that room, indicating that the patient had moved.

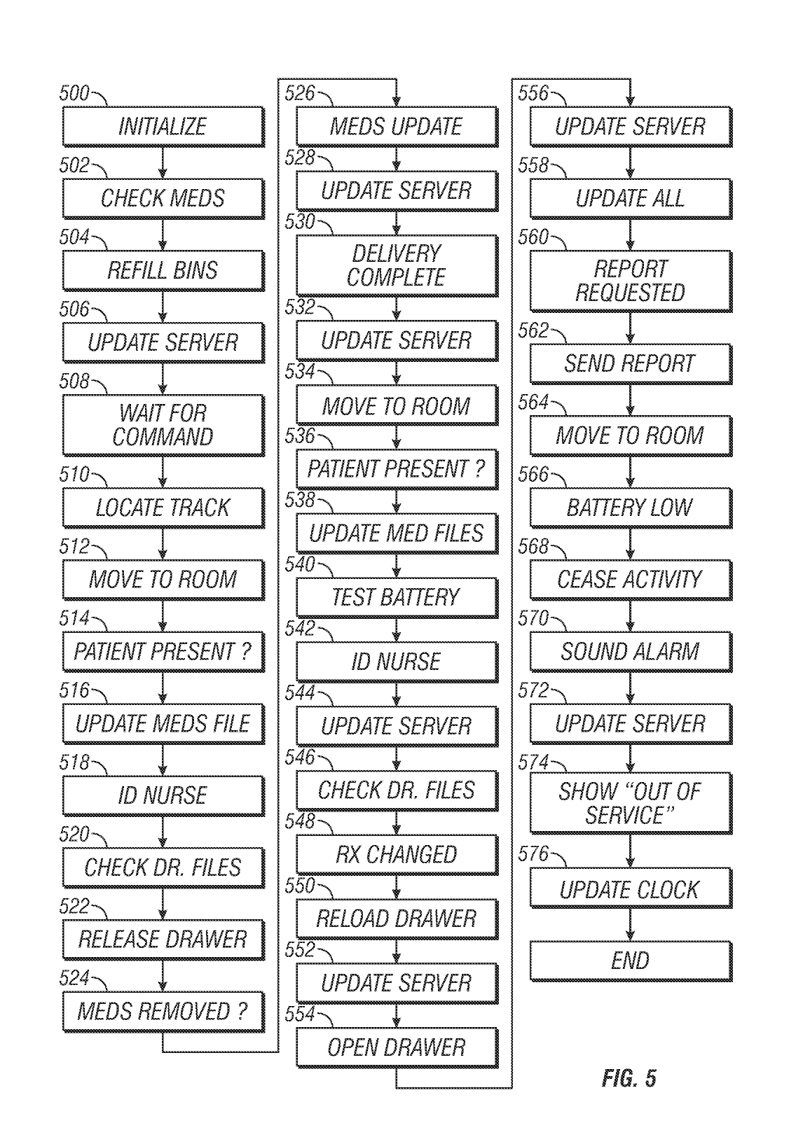

FIG. 5 illustrates the internal operation of the meds cart. The operation begins at 500, where the initialization occurs. At 500 to the system checks the meds, at 504 bins are refilled or refill is requested, and at 506 the server is updated. The cart then waits for commands at 508. At 510 the movement begins to occur, with the med cart locating the track. The cart moves to the first room at 512 and determines if the patient is present. If so, it updates the meds files at 516, IDs the nurse at 518, checks the doctor files at 520, and releases the drawer at 522 that thereby provides the meds in the bin for dispensing. 524 determines if the meds have been removed. If so, the meds are updated at 526, and the server is updated at 528. This indicates that the delivery is completed 530 which also updates the server at 532. The cart then moves to the next room at 534, determines if the patient is present at 536, updates the med files at 538.

The cart may continually test its batteries at 540, and this may be the time at which the batteries are tested. At 542 the system IDs the nurse, and updates the server at 545. At 546 the system checks the doctor files, determines if the prescription has changed at 548. Otherwise, the system may reload the drawer at 550, update the server at 552 and then open the drawer at 554. At each step, including opening the drawer, the server is updated.

At 556 the server is updated again, followed by a global update at 558. At 560, a report is requested, and this is sent at 562. The system then moves to the next room at 564. If at any time, the battery is low, for example as tested at 540, than a battery low routine starts at 566. This causes activity to cease at 568 followed by an alarm being sounded at 570 and the server being updated at 572. The cart then displays “out of service” at 574.

The clock is shown as being continually updated at 576.

In one embodiment of the above, the bins are filled with medication, and the cart automatically dispenses these medications into a pigeonhole which is opened based on the different tests which are carried out including whether the patient is in the proper room. In another embodiment, however, the pigeonholes can be pre-dispensed by the pharmacist, for example, with each pigeonhole representing an action for specific patient.

In another embodiment, this can the same system can be used for dispensing alcoholic beverages in an automated system. For example, the cart can be a roving cart that can automatically dispense alcoholic beverages, either using pre-measured shots or by dispensing one shot at any given time based on the user identify themselves. For example, users may be given RFID arm bracelets or barcode scanners that can be scanned into either a station or into the cart itself, at which time the cart will determine the user's order, arrange the billing information, and dispense a drink.

In one embodiment, a user can summon the cart, by requesting a drink, at which time the card is sent to the user's location to provide the drink(s).

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other hardware and software can be used. Moreover, while this describes use with metering of drugs and alcohol, this can also be used for other inventory control purposes such as for dispensing inventory for example in an automated inventory system.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A portable item dispensing system, comprising:
a portable assembly, having a housing, a dispensing surface, and an item holding area attached to said housing, and a movement part that allows the system to be moved, a computer, coupled to said housing, a wireless transmitter and wireless receiver, coupled to said computer to communicate information from said computer,
wherein said computer is programmed to automatically check stock of at least plural dispensable items, to automatically determine whether a first set of dispensable items can be dispensed to a specified person, automatically obtaining said first set of dispensible items and automatically dispensing said first set of dispensible items when said first set of dispensible items can be automatically dispensed and automatically communicating to a server that the item has been dispensed.

2. A system as in claim 1, wherein said dispensable item is doses of drugs.

3. A system as in claim 2, wherein said system automatically receives prescription information using said wireless receiver and automatically determines said doses from said prescription information.

4. A system as in claim 3, wherein said system stores multiple drugs, and automatically creates said first set of dispensible items responsive to receiving said prescription information, and places said first set of dispensible items in an individual bin and automatically opens said individual bin.

5. A system as in claim 4, wherein said system automatically verifies said prescription information using said wireless transmitter, prior to opening said individual bin.

6. A system as in claim 4, wherein said system automatically determines its location, and automatically determines one of plural different bins to open based on its location and an expected location of a patient at that location.

7. A system as in claim 1, wherein said system stores information about a plurality of different sets of dispensible items to be provided out to a plurality of different people, automatically determines its location, and automatically opens a bin to dispense contents of the bin to a person at said location.

8. A system as in claim 7, further comprising a sensor which detects and identifies a person at a specified location prior to said dispensing.

9. A system as in claim 6, wherein said system is self-propelled, and automatically moves to said expected location.

10. A system as in claim 1, wherein said dispensible items are alcoholic beverages.

11. A method of dispensing, comprising:
storing a plurality of dispensible items in separate item holding areas in a portable assembly;
using a computer in said assembly that has a wireless transmitter and receiver, to communicate information to and receive information from a central server;
using said computer to automatically check stock of at least plural dispensable items;
using said computer to automatically determine whether a first set of dispensable items can be dispensed to a specified person;
moving said portable assembly to a location of the specified person; and
automatically obtaining said first set of dispensible items and automatically dispensing said first set of dispensible items and automatically communicating billing information about said items being automatically dispensed to said server using said wireless transmitter.

12. A method as in claim 11, wherein said dispensable item is doses of drugs.

13. A method as in claim 12, wherein said computer automatically receives prescription information using said wireless receiver and automatically determines said first set of dispensible items from said prescription information.

14. A method as in claim 13, wherein said separate item holding areas respectively store multiple different kinds of drugs, and said computer controls a device to automatically create said first set of dispensible items responsive to receiving said prescription information, and to place said first set of dispensible items in an individual bin and to automatically open said individual bin based on a detection.

15. A method as in claim 14, wherein said detection includes automatically verifying said prescription information using said wireless transmitter, prior to opening said individual bin.

16. A method as in claim 14, further comprising automatically determining a location of said portable assembly, and automatically determining one of plural different bins to open based on its location and an expected location of a person at said location.

17. A method as in claim 11, wherein said method stores information about a plurality of different sets of dispensible items to be provided out to a plurality of different people, automatically determines a location of said portable assembly, and automatically opens a bin to dispense contents of the bin to a person at said location.

18. A method as in claim 17, further comprising a sensor which detects and identifies a person at a specified location prior to said dispensing.

19. A method as in claim 16, further comprising automatically moving said portable assembly to said location.

20. A method as in claim 11, wherein said dispensible items are alcoholic beverages.
